(19) United States
(12) Patent Application Publication
(10) Pub. No.: US 2008/0002641 A1
(43) Pub. Date: Jan. 3, 2008

(54) Media type access category based load leveling for a wireless network

(75) Inventors: Deanna Hong, Palo Alto, CA (US); Mike Shiba, San Jose, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/479,863

(22) Filed: Jun. 30, 2006

(51) Int. Cl. H04Q 7/24

(52) U.S. Cl. 370/338

(57) ABSTRACT

A method for automatically determining the amount of currently utilized bandwidth on infrastructure devices such as wireless access points in a wireless network is disclosed. The method begins by a mobile client device receiving load leveling information from infrastructure devices corresponding to media type access categories. Based upon the load leveling information, the amount of currently utilized bandwidth by media type access categories on the infrastructure devices is determined and an infrastructure device with bandwidth sufficient to support at least one of the media type access categories intended for use by the mobile client device is selected.

### TECHNICAL FIELD

The present invention relates generally to preemptive roaming among cells in a wireless network. More particularly, the present invention relates to automatic and semi-automatic load leveling in wireless local area networks including a plurality of mobile units and a plurality of access points.

### BACKGROUND

Wireless local area networks (“WLANs”) can give mobile client devices the ability to “roam” or physically move from place to place while maintaining a wireless connection to a local area network without being connected by wires. In the context of a WLAN, the term “roaming” describes the act of a mobile client device moving between wireless access devices, which may be stand-alone wireless access points that cooperate with infrastructure located in the WLAN. Many deployments of wireless computer infrastructure, such as WLANs, involve the use of multiple wireless access devices serving a number of mobile client devices. These conventional networks do not automatically or intelligently distribute the access devices among the mobile client devices.

A WLAN relies on infrastructure components that establish associations, such as data communication links, with mobile client devices. A mobile client device communicates, via a wireless data communication channel, with an access point device, which in turn communicates with other network components via traditional wired interfaces. A WLAN infrastructure may be configured to support a plurality of mobile clients using a single access point device. In other words, one access point device can support a plurality of different groups or categories of client devices each with a wide range of possible data rate or bandwidth requirements.

The IEEE 802.11 protocol supports frequency hopping; direct sequence spread spectrum systems, and infrared communications. In order to achieve interoperability of the various mobile clients with various access point devices, extensions to IEEE 802.11 provide standards for various features associated with interoperability in a WLAN. For example, wireless multimedia extensions (“WME”), also known as Wi-Fi Multimedia (“WMM”), is an interoperability certification based on the IEEE 802.11e standard. It provides quality of service (“QoS”) features for IEEE 802.11 networks. WME/WMM prioritizes traffic through a WLAN according to four access categories namely voice, video, best effort, and background. Generally, the voice category corresponds to digitally encoded sound, the video category corresponds to digitally encoded imaging, the best effort category corresponds to whatever data rate is available, and the background category corresponds to data that is sent only when bandwidth is available. Although each access category has different data rate and bandwidth requirements, there is no provision for guaranteed throughput.

In this regard, wireless networks may become saturated or overloaded due to overlapping demands for bandwidth in each access category by a plurality of mobile clients using a single access point device. It is desirable to have a way to organize the bandwidth demands for specific WMM/WME applications from the mobile clients in order for an access point device not to be overloaded.

### BRIEF SUMMARY

A method for automatically determining the amount of currently utilized bandwidth for each WMM/WME access category on infrastructure devices such as wireless access points in a wireless network is disclosed. To form an association such as a data communication link between a mobile client device and a wireless access point, a mobile client device will require sufficient unutilized bandwidth for transmitting data such as the WMM/WME access categories of video, voice, best-effort, and/or background. After considering the currently utilized bandwidth for one or more WMM/WME access categories on the wireless access points, a wireless access point determined to have sufficient unutilized bandwidth may be selected for association.

The method begins by a mobile client device receiving WMM/WME load leveling information and a received signal strength indicator (“RSSI”) for a plurality of infrastructure devices in a WLAN network. The WMM/WME load leveling information may be load measures such as the total number of associated mobile client devices that support each WMM/WME access category and the current load for each WMM/WME access category on the infrastructure device. This load leveling information may include, for example, frames per second, bytes per second, a percent bandwidth utilized for each access category supported by each infrastructure device, or a total percent bandwidth available on a data communication medium in the wireless network. Based upon the load leveling information, the current load and the amount of a current utilized bandwidth for each WMM/WME access category on each infrastructure device is determined. The mobile client device selects an infrastructure device for association corresponding to the infrastructure device with the highest RSSI having a sufficient unutilized bandwidth to support at least one of the WMM/WME access categories intended for use by the mobile client device and a having lowest current load. Once the infrastructure device is selected, the mobile client device may initiate an association with the infrastructure device, or if there is an insufficient bandwidth, or the current load is not sufficiently low association is prevented and the mobile client device can search for an infrastructure device with sufficient unutilized bandwidth and a lowest current load.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a simplified schematic representation of a typical WLAN infrastructure suitable for use in connection with an example embodiment of the invention;

FIG. 2 is a schematic representation of an infrastructure device configured in accordance with an example embodiment of the invention;

FIG. 3 is a schematic representation of a mobile client device configured in accordance with an example embodiment of the invention;

FIG. 4 is a schematic representation of a WLAN environment having three access points and four mobile client devices;

FIG. 5 is a flow chart of a mobile client device association process in accordance with an example embodiment of the invention; and

FIG. 6 is a flow chart of a wireless infrastructure device load leveling process in accordance with an example embodiment of the invention.

### DETAILED DESCRIPTION

The following detailed description is illustrative in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to wireless signal processing, wireless data transmission, WLANs, signaling, network control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description may refer to elements or features being “connected” or “coupled” together. As used herein, unless expressly stated otherwise, “connected” means that one element/feature is directly joined to (or directly communicates with) another element/feature, and not necessarily mechanically. Likewise, unless expressly stated otherwise, “coupled” means that one element/feature is directly or indirectly joined to (or directly or indirectly communicates with) another element/feature, and not necessarily mechanically. Thus, although the figures may depict example arrangements of elements, additional intervening elements, devices, features, or components may be present in an actual embodiment (assuming that the functionality of the system is not adversely affected).

As used herein, the term “access point” means any component, device, feature, element, or function that is configured to receive/transmit wireless traffic from a wireless client device in a WLAN environment. Traditionally, an access point or an access point device refers to a hardware component that includes a radio module, memory, processing logic, and a network communication module that enables it to communicate with other network architecture components. For convenience, the term “access point” as used herein contemplates an access point device in the traditional sense, in addition to a subsystem that includes an access port device and a wireless switch. Moreover, the term “access point” contemplates any individual component, device, hardware, or system, and any combination thereof, that is configured to function in the manner described herein. For example, the load leveling features described herein may be implemented in an untraditional architecture that combines the necessary radio module, processing power, memory, and the like with additional features not typically found in conventional stand-alone access point devices.

The WMM Specification (by Wi-Fi Alliance; www.wi-fi.org) provides for the distribution of WMM parameters to mobile users in 802.11 beacons, probe responses, and association responses. Any WMM documentation publicly available from Wi-Fi Alliance, either online or otherwise, and IEEE Standard 802.11 (all variants) are incorporated by reference herein. In particular, “Wi-Fi CERTIFIED™ for WMM™—Support for Multimedia Applications with Quality of Service in Wi-Fi® Networks,” Wi-Fi Alliance (Sep. 1, 2004) is incorporated by reference herein.

The WMM specification, from Wi-Fi Alliance, is a subset of the IEEE 802.11e specification. WMM/WME relates to the handling of multimedia over a WLAN. WMM generally specifies a technique for prioritizing data depending upon the type of data being transmitted. For example, voice data and video data, which is typically sensitive to transmission delay, may be prioritized higher than other data, such as web browser traffic, that is not as time sensitive. Thus, a transmitter (for either a mobile client device or infrastructure devices) will use different parameters depending upon the type of data. In the example embodiment, there are four WMM priority levels, corresponding to four WMM/WME access categories. The WMM priority levels (in increasing order) are: background; best effort; video; and voice. The priority levels are mapped to the eight priority levels set forth in IEEE Standard 802.11d; the content of which is incorporated by reference herein. For example, more aggressive parameters can be used for voice and video, thus increasing the likelihood that such data will be transmitted quickly. An infrastructure device delivers load leveling information for each WMM/WME access category to the mobile clients. Each mobile client device then uses the load leveling information when communicating with the infrastructure device.

The WMM/WME load leveling information is delivered using 802.11 beacons, probe responses, and association responses, which are management frames. A beacon is broadcast from an access point on a periodic basis. When a mobile client device is searching for a network, it transmits a probe frame. An access point within range of the mobile client device will respond with a probe response. If the mobile client device is seeking a network connection, then it sends an association request to the access point. An association response, which is sent by the access point in response to an association request, is utilized to establish the communication channel between the mobile client device and the access point.

Disclosed herein is a method for automatically load leveling a WLAN by determining the amount of currently utilized bandwidth on infrastructure devices, such as wireless access points, in a wireless network. The method begins by a mobile client device receiving WMM/WME load leveling information. Based upon the load leveling information, the amount of the current utilized bandwidth for each WMM/WME access category on each infrastructure device is determined. The mobile client device selects an infrastructure device for association corresponding to the highest RSSI, the lowest current load and having a sufficient unutilized bandwidth to support at least one of the WMM/WME access categories intended for use by the mobile client device.

A WLAN relies on infrastructure components that establish data communication links with mobile client devices. A mobile client device communicates, via a wireless data communication channel, with an access point, which in turn communicates with other network components via traditional wired interfaces. A WLAN may also include wireless switches as needed. A WLAN infrastructure may be configured to support a plurality of mobile clients using a single access point device. In other words, one access point device can support a plurality of different groups or categories of mobile clients each with a wide range of possible data rate or bandwidth requirements.

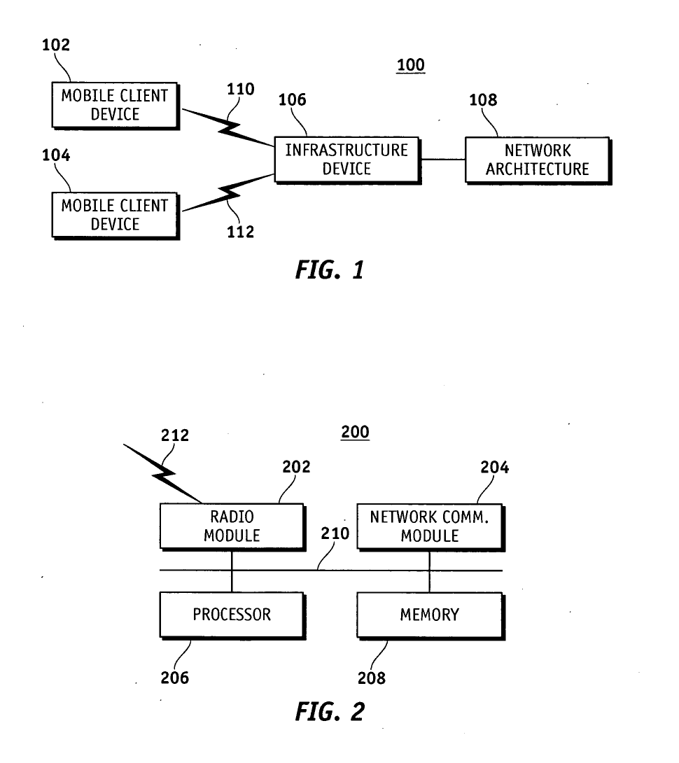

FIG. 1 is a simplified schematic representation of a typical WLAN infrastructure 100, including mobile client devices 102/104, an infrastructure device 106 such as an access point, and a network architecture 108. As explained above, infrastructure device 106 may be realized as a subsystem that includes an access port device and one or more components of network architecture 108, e.g., a wireless switch. A practical WLAN infrastructure 100 may include any number of mobile client devices and any number of access points dispersed throughout the area of coverage. A mobile client device can be any computing device having the wireless transceiver and interface capabilities necessary to communicate with access point 106 via wireless links 110/112. Although not shown in FIG. 1 for clarity, WLAN infrastructure 100 may include one or more wireless switches coupled between access points and network architecture 108. Infrastructure device 106 can communicate with the remaining network architecture 108 via any suitable data communication link 114, such as an Ethernet data cable. Network architecture 108 may include any number of traditional computer network components, including, but not limited to: switches, routers, servers, interfaces, data storage devices, or the like.

FIG. 2 is a schematic representation of an infrastructure device 200 configured in accordance with an example embodiment of the invention. A practical embodiment of infrastructure device 200 will include additional components and elements configured to support known or conventional operating features that need not be described in detail herein. In the example embodiment, infrastructure device 200 is a wireless access point that transmits and receives data. An access point connects users to other users within the network and can also serve as the point of interconnection between a WLAN and a fixed wire network. Each access point can serve multiple users within a defined network area. As a wireless client moves beyond the range of one access point, the mobile client device associates to another access device, e.g., a different access point. In practice, the number of infrastructure devices in a given network generally increases with the number of network users and the physical size of the network.

Infrastructure device 200 generally includes a physical housing (not shown), a radio module 202, a network communication module 204, a processor architecture 206, and an appropriate amount of memory 208. A practical infrastructure device 200 may include any number of radio modules, any number of network communication modules, any number of processor devices, and any number of memory elements; the illustrated device depicts a simple embodiment for ease of description. These and other elements of infrastructure device 200 may be interconnected together using a bus 210 or any suitable interconnection arrangement. Such interconnection facilitates communication between the various elements of wireless access device 200. Those of skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the present invention.

Radio module 202, which includes a receiver and a transmitter (or a transceiver), is configured to communicate with mobile client devices via a wireless data communication link 212. Radio module 202 may cooperate with a suitably configured RF antenna arrangement (not shown) that supports the particular wireless communication protocol. In the example embodiment, radio module 202 is configured to support WLAN connectivity in compliance with established IEEE standards, such as 802.11, 802.11a, 802.11b, 802.11d. 802.11e and 802.11g. Of course, radio module 202 may be configured to support alternate or additional wireless data communication protocols, including future variations of 802.11 such as 802.11n.

Network communication module 204 generally represents the hardware, software, firmware, processing logic, and/or other components of wireless access device 200 that enable bi-directional communication between infrastructure device 200 and network components to which wireless access device 200 is connected. For example, network communication module 204 may be configured to support 10/100 Mbps Ethernet LAN traffic. Referring to FIG. 1 as an example, network communication module 204 is suitably configured to transmit data to components in network architecture 108, and to receive data from components in network architecture 108. In a typical deployment, network communication module 204 provides an Ethernet interface such that wireless access device 200 can communicate with a conventional Ethernet-based computer network. In this regard, network communication module 204 may include a physical interface, such as 10/100/1000 Mbps, for connection to the computer network, and network communication module 204 (and/or processor 206) may handle Ethernet addressing for data packets sent from wireless access device 200.

Processor architecture 206 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. In practice, processor architecture 206 includes processing logic that is configured to carry out the functions, techniques, and processing tasks associated with the operation of wireless access device 200. In particular, the processing logic is configured to support the load leveling techniques described herein. As mentioned above, in practical embodiments the processing logic may be resident in an access point device that includes radio module 202, or in a wireless switch (which may be considered to be part of network architecture 108) that communicates with an access port device that includes radio module 202.

Furthermore, the steps of a method or algorithm described in connection with the embodiments disclosed herein may be embodied directly in hardware, in firmware, in a software module executed by processor architecture 206, or in any practical combination thereof. A software module may reside in memory 208, which may be realized as RAM memory, flash memory, ROM memory, EPROM memory, EEPROM memory, registers, a hard disk, a removable disk, a CD-ROM, or any other form of storage medium known in the art. In this regard, memory 208 can be coupled to processor architecture 206 such that processor architecture 206 can read information from, and write information to, memory 208. In the alternative, memory 208 may be integral to processor architecture 206. As an example, processor architecture 206 and memory 208 may reside in an ASIC.

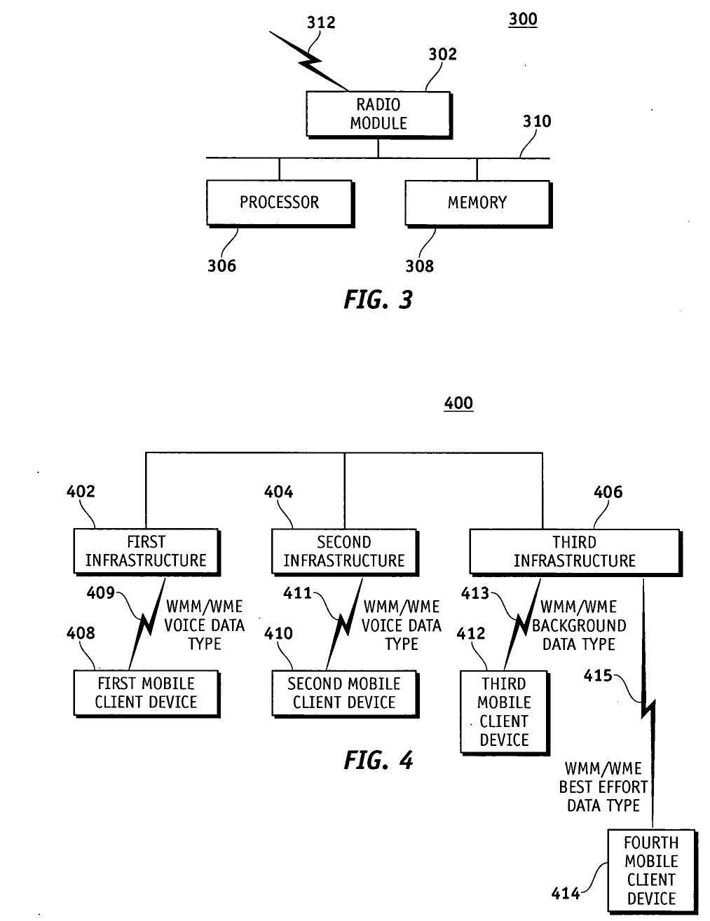

FIG. 3 is a schematic representation of a mobile client device 300 configured in accordance with an example embodiment of the invention. A practical embodiment of mobile client device 300 will include additional components and elements configured to support known or conventional operating features that need not be described in detail herein. In the example embodiment, the mobile client device 300 transmits and receives data wirelessly to and from the infrastructure device 106. An infrastructure device connects mobile client devices to other users within the network and can also serve as the point of interconnection between a WLAN and a fixed wire network. Each infrastructure device can serve multiple mobile client devices within a defined network area. As a mobile client device moves beyond the range of one infrastructure device, the mobile client device can associate to another infrastructure device, e.g., a candidate infrastructure device. A mobile client device may be, for example, without a limitation, a wireless laptop computer or a mobile phone.

Mobile client device 300 generally includes a physical housing (not shown), a radio module 302, a processor architecture 306, and an appropriate amount of memory 308. A practical mobile client device 300 may include any number of radio modules, any number of processor devices, and any number of memory elements; the illustrated device depicts a simple embodiment for ease of description. These and other elements of mobile client device 300 may be interconnected together using a bus 310 or any suitable interconnection arrangement. Such interconnection facilitates communication between the various elements of mobile client device 300.

Radio module 302, which includes a receiver and a transmitter (or a transceiver), is configured to communicate with infrastructure devices via a wireless data communication link 312. Radio module 302 may cooperate with a suitably configured RF antenna arrangement (not shown) that supports the particular wireless communication protocol. In the example embodiment, radio module 302 is configured to support WLAN connectivity in compliance with established IEEE Standards, such as 802.11, 802.11a, 802.11b, 802.11d, 802.11e and 802.11g. Radio module 302 may be configured to support alternate or additional wireless data communication protocols, including future variations of 802.11 such as 802.11n.

Processor architecture 306 may be implemented or realized in the manner described above for processor architecture 206 (see FIG. 2). In practice, processor architecture 306 includes processing logic that is configured to carry out the functions, techniques, and processing tasks associated with the operation of mobile client device 300. In particular, the processing logic is configured to support the load leveling techniques described herein.

Furthermore, the steps of a method or algorithm described in connection with the embodiments disclosed herein may be embodied directly in hardware, in firmware, in a software module executed by processor architecture 306, or in any practical combination thereof. A software module may reside in memory 308, which may be realized as RAM memory, flash memory, ROM memory, EPROM memory, EEPROM memory, registers, a hard disk, a removable disk, a CD-ROM, or any other form of storage medium known in the art. In this regard, memory 308 can be coupled to processor architecture 306 such that processor architecture 306 can read information from, and write information to, memory 308. In the alternative, memory 308 may be integral to processor architecture 306. As an example, processor architecture 306 and memory 308 may reside in an ASIC.

FIG. 4 is a schematic representation of a WLAN environment 400 having three infrastructure devices connected in a common WLAN infrastructure and having four mobile client devices in association with the common WLAN infrastructure. WLAN environment 400 depicts an example communication session that may be carried out by components in the network shown in FIG. 1. In this simplified example, three infrastructure devices 402/404/406 are depicted, along with four mobile client devices 408/410/412/414. This simplified arrangement facilitates the following description of the example communication session, and is not intended to limit the scope or application of the invention in any way.

Each infrastructure device shown in FIG. 4 may represent a different logical WLAN having different bandwidth and data rate capabilities for each WMM/WME access category. According to one example embodiment of this invention, a first mobile client device 408 is communicating with the first infrastructure device 402, and the first infrastructure device has bandwidth sufficient to support a WMM/WME voice data type intended for use by the first mobile client device 408 using the communication link 409. A second mobile client device 410 is communicating with the second infrastructure device 404, and the second infrastructure device 404 has bandwidth sufficient to support the WMM/WME video data type intended for use by the second mobile client 410 using the communication link 411. A third mobile client device 412 is communicating with the third infrastructure device 406, which has bandwidth sufficient to support the WMM/WME background data type data type intended for use by the third mobile client device 412 using the communication link 413. Moreover, the fourth mobile client device 414 is also communicating with the third infrastructure device 406, which has bandwidth sufficient to support a WMM/WME best effort type data type using communication link 415.

As the mobile client devices 408/410/412/414 move around the environment 400, a different infrastructure device may support communication using the same or different bandwidth and data rates as available for the WMM/WME access categories intended for use by the mobile client devices 48/410/412/414. In this regard, each mobile client device selects an infrastructure device having bandwidth sufficient to support at least one of the WMM/WME access categories intended for use by the mobile client device as explained in detail below.

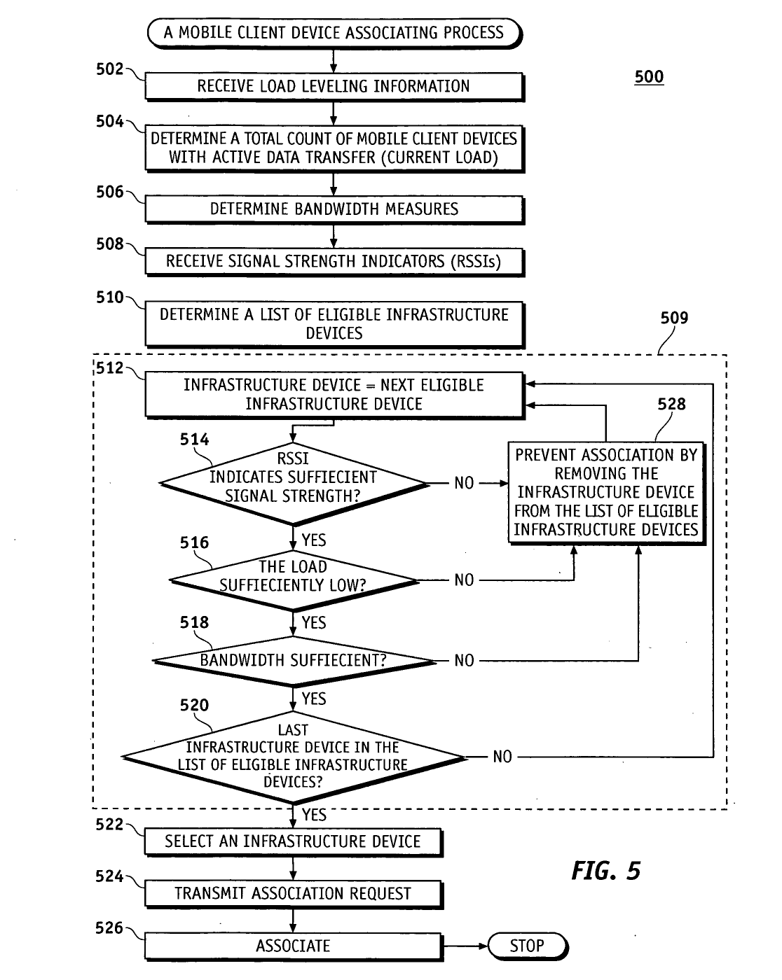

FIG. 5 is a flow chart of a mobile client device association process 500 in accordance with an example embodiment of the invention, which may be suitable for 802.11 direct sequence and OFDM WLAN radios. Process 500 may be performed by a mobile client device configured in accordance with an example embodiment of the invention, and process 500 may be carried out in conjunction with the communication session depicted in FIG. 4. The various tasks performed in connection with process 500 may be performed by software, hardware, firmware, or any combination thereof. For illustrative purposes, the following description of process 500 may refer to elements mentioned above in connection with FIGS. 1-4. In practical embodiments, portions of process 500 may be performed by different elements of the described systems. It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein.

Process 500 may begin by receiving load leveling information corresponding to media type access categories from infrastructure devices in the wireless network (task 502). For each of the infrastructure devices, the load leveling information may include a first current load indicator for a first media type access category, a second current load indicator for a second media type access category (and so on) and a total count of mobile client devices associated with each media type access category for the respective infrastructure device. In this example, each media type access category corresponds to a WMM/WME access category, as mentioned above, the WMM/WME access categories include a voice data type category, a video data type category, a best effort data type category and a background data type category.

For a given connection, the mobile client device will require sufficient bandwidth for transmitting each media type access category, and the bandwidth requirement can vary depending upon the particular access category. Based upon the load leveling information, received in step 502, the amount of the currently utilized bandwidth is determined for the infrastructure devices. Process 500 continues with determining, based upon the load leveling information, a total count of mobile client devices associated with each media type access category for the respective infrastructure device (task 504) (the current load). The current load is indicative of a total number of mobile client devices each having an active data transfer for communicating at least one of the media type access categories.

Process 500 then continues with determining, based upon the load leveling information, a plurality of bandwidth measures that are indicative of current bandwidth utilized by the plurality of media type access categories on each of the plurality of infrastructure devices (task 506). The bandwidth measures may include, without limitation, frames per second, bytes per second, a percent bandwidth utilized per access category, and a total percent bandwidth available on a data communication medium.

When determining the current load and bandwidth measures for each media type access category, the mobile client device also takes into account the current load and bandwidth measures of higher priority media type access categories. For example, voice data type is the highest priority media type access category and video is second highest priority media type access category, the current load and bandwidth measures on the video is the combination of current load and bandwidth measures on the voice data type access category and the video data type access category.

Next, process 500 obtains an RSSI (task 508) from each infrastructure device. RSSI is an indication of the infrastructure signal quality and each mobile client device may select a group of eligible infrastructure devices and select the most eligible infrastructure device from that group. The mobile client device then determines a list of eligible infrastructure devices for association (task 510), which are infrastructure devices that are detectable and available for association.

Then based upon the current load and the bandwidth measures, the mobile client sorts through the list of eligible infrastructure devices to search for an infrastructure device having sufficient bandwidth and a sufficiently low current load to support at least one of the media type access categories. The sorting 509 begins by selecting a next eligible infrastructure device (task 512). If the mobile client device determines that for the next eligible infrastructure device: the RSSI indicated insufficient signal strength (inquiry task 514), the current load is not sufficiently low (inquiry task 516), or the bandwidth is insufficient (inquiry task 518), then process 500 prevents association with the infrastructure device by removing the infrastructure device from the list of eligible infrastructure devices (task 528). After task 528, the sorting 509 then proceeds to the next eligible infrastructure device (task 512) to continue sorting through the list of the eligible infrastructure devices to search for infrastructure devices having sufficient bandwidth and current load to support at least one of the media type access categories.

If the mobile client device determines that: the RSSI indicated sufficient signal strength (inquiry task 514), the current load is sufficiently low (inquiry task 516), and the bandwidth on an infrastructure device is sufficient to support at least one of the plurality of media type access categories intended for use by the mobile client device (inquiry task 518), then process 500 checks if all eligible infrastructure devices have been considered by checking if the last infrastructure device in list of eligible infrastructure devices has been reached (inquiry task 520). If the sorting 509 has not reached the last infrastructure device in list of eligible infrastructure devices (inquiry task 520), then process 500 leaves the present eligible infrastructure device in the list of eligible infrastructure devices, and continues the sorting 509 by proceeding to the next eligible infrastructure device (task 512) in the list of eligible infrastructure devices. If the sorting 509 has reached the last infrastructure device in list of eligible infrastructure devices (inquiry task 520), then the sorting 509 ends and process 500 selects an infrastructure device (task 522).

Process 500 selects an infrastructure device (task 522) from the remaining eligible infrastructure devices in the list of eligible infrastructure devices with the following criteria: the infrastructure device has sufficient bandwidth to support at least one of the plurality of media type access categories intended for use by the mobile client device; and the infrastructure device has the lowest total count of currently connected mobile client devices (the lowest current load), where each currently connected mobile client device has an active data transfer for communicating at least one of the media type access categories. The media type access categories applicable may be, without limitation, voice data type, video data type, a best effort data type, or a background data type being processed by the mobile client device.

Finally, process 500 prompts the mobile client device to transmit an association request (task 524) in an attempt to associate with the selected infrastructure device (task 526).

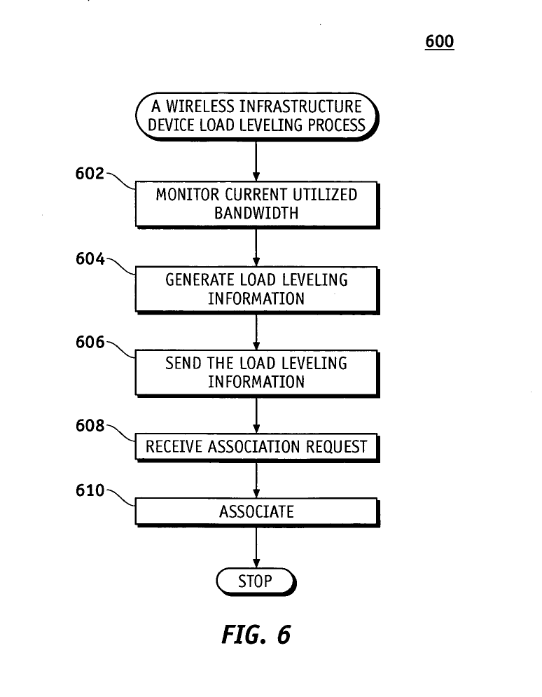

Each infrastructure device generates and sends its respective load leveling information for each WMM/WME access category to the mobile client devices. FIG. 6 is a flow chart of a wireless infrastructure device load leveling process 600 in accordance with an example embodiment of the invention. Process 600 may be carried out in conjunction with the communication session depicted in FIG. 4.

Process 600 may begin by monitoring the current utilized bandwidth corresponding to a plurality of media type access categories for one or more mobile client devices supported by the wireless infrastructure device (task 602). Process 600 differentiates between media type access categories (WMM/WME access categories) and proceeds to generate, based upon the current utilized bandwidth, load leveling information for each of the media type access categories (task 604). Process 600 then sends the load leveling information (task 606) to at least one of the mobile client devices. As mentioned above, the WMM/WME access categories correspond to a set of priority levels (based upon data type) such as a voice priority level, a video priority level, a best effort priority level, and a background priority level. In this regard, by differentiating loads within the access categories a mobile client device may find that, for example, its voice data type will have sufficient bandwidth, even though the overall bandwidth utilized by its associated infrastructure device is high. Since the mobile client device has sufficient bandwidth, the mobile client device sends an association request to one of the infrastructure devices. The infrastructure device may then receive an association request (task 608) and may associate (by sending an association response) with the mobile client device (task 610). This ensures that the infrastructure device can adequately support the WMM/WME access category intended for use by the mobile client device. However, if there is not sufficient bandwidth to support at least one of the access categories intended for use by the mobile client device, the mobile client device may search for other eligible infrastructure devices as explained above in the context of FIG. 5.

In this regard, to maximize performance and balance the loading of the WLAN network, a mobile client device, when preemptively roaming, may choose to connect to the infrastructure device best suited to transmit data for its intended WMM/WME access category. If sufficient bandwidth cannot be found to support the intended WMM/WME access category on any of the infrastructure devices within the wireless range of the mobile client device, the mobile client device may choose not to initiate a connection.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method for associating a mobile client device with a wireless infrastructure device in a wireless network, the method comprising:
receiving load leveling information corresponding to a plurality of media type access categories from a plurality of infrastructure devices in the wireless network;
determining, based upon the load leveling information, a plurality of bandwidth measures that are indicative of current bandwidth utilized by the plurality of media type access categories on each of the plurality of infrastructure devices; and
selecting, based upon the plurality of bandwidth measures, one of the plurality of infrastructure devices.

2. A method according to claim 1, wherein the selecting step further comprises:
determining a list of eligible infrastructure devices for association;
selecting, from the list of eligible infrastructure devices, an infrastructure device having bandwidth sufficient to support at least one of the plurality of media type access categories intended for use by the mobile client device; and
selecting, from the list of eligible infrastructure devices, an infrastructure device having a lowest total count of mobile client devices wherein each of the mobile client devices having an active data transfer for communicating the at least one of the plurality of media type access categories.

3. A method according to claim 2, further comprising:
preventing association with an infrastructure device not having bandwidth sufficient to support the at least one of the plurality of media type access categories intended for use by the mobile client device; and
sorting through the list of eligible infrastructure devices to search for the infrastructure device having sufficient bandwidth to support the at least one of the plurality of media type access categories.

4. A method according to claim 2, further comprising:
preventing association with an infrastructure device not having the lowest total count of mobile client devices; and
sorting through the list of eligible infrastructure devices to search for the infrastructure device having the lowest total count of mobile client devices.

5. A method according to claim 1, further comprising transmitting an association request to the selected one of the plurality of infrastructure devices.

6. A method according to claim 1, wherein for each of the infrastructure devices the load leveling information comprises a first current load indicator for a first media type access category and a second current load indicator for a second media type access category.

7. A method according to claim 1, wherein the determining step further comprises determining a total count of mobile client devices each having an active data transfer for communicating at least one of the plurality of media type access categories.

8. A method according to claim 1, wherein the load leveling information for each of the plurality of infrastructure devices comprises:
a total count of mobile client devices associated with each media type access category for the respective infrastructure device, frames per second, bytes per second, a percent bandwidth utilized per access category, and a total percent bandwidth available on a data communication channel in the wireless network.

9. A method according to claim 1, wherein the media type access categories correspond to a plurality of WMM/WME access categories.

10. A method according to claim 9, wherein the WMM/WME access categories comprise a voice data type category, a video data type category, a best effort data type category, and a background data type category.

11. A mobile client device configured for operation in a wireless network, the mobile client device comprising:
a radio module configured to wirelessly receive signals that convey load leveling information corresponding to a plurality of media type access categories from infrastructure devices in the wireless network; and
a processing logic element coupled to the radio module and configured to:
determine, based upon the load leveling information, a plurality of bandwidth measures that are indicative of current bandwidth utilized by the plurality of media type access categories on each of the infrastructure devices; and
select, based upon the plurality of bandwidth measures, one of the infrastructure devices.

12. A mobile client device according to claim 11, wherein for each of the infrastructure devices the load leveling information comprises a first current load indicator for a first media type access category and a second current load indicator for a second media type access category.

13. A mobile client device according to claim 11, wherein the load leveling information comprises:
a total count of the mobile client devices associated with each media type access category for the infrastructure device, frames per second, bytes per second, a percent bandwidth utilized per access category, and a total percent bandwidth available on a data communication channel in the wireless network.

14. A mobile client device according to claim 11, wherein the selecting step selects one of the infrastructure devices having bandwidth sufficient to support at least one of the media type access categories intended for use by the mobile client device.

15. A mobile client device according to claim 11, wherein the selecting step selects one of the infrastructure devices having a lowest total count of mobile client devices wherein each of the mobile client devices having an active data transfer for communicating at least one of the plurality of media type access categories.

16. A mobile client device according to claim 11, wherein the media type access categories correspond to a plurality of WMM/WME access categories.

17. A mobile client device according to claim 16, wherein the WMM/WME access categories comprise a voice data type category, a video data type category, a best effort data type category, and a background data type category.

18. A method for automatically load leveling a wireless infrastructure device in a wireless network, the method comprising:
monitoring current utilized bandwidth corresponding to a plurality of media type access categories for one or more mobile client devices supported by the wireless infrastructure device;
generating, based upon the current utilized bandwidth, load leveling information for each of the plurality of media type access categories; and
sending the load leveling information to at least one mobile client device.

19. A method according to claim 18, wherein the generating step further comprises differentiating between the plurality of media type access categories.

20. A method according to claim 18, further comprising associating, based upon the load leveling information, with a mobile client device that supports the plurality of media type access categories.

21. A method according to claim 18, wherein the load leveling information comprises a first current load indicator for a first media type access category and a second current load indicator for a second media type access category.

22. An infrastructure device configured for operation in a wireless network, the infrastructure device comprising:
a radio module configured to wirelessly transmit signals that convey load leveling information corresponding to a plurality of media type access categories to mobile client devices in the wireless network; and
a processing logic element coupled to the radio module and configured to:
monitor current utilized bandwidth corresponding to a plurality of media type access categories for one or more mobile client devices supported by the wireless infrastructure device;
generate, based upon the current utilized bandwidth, load leveling information for each of the plurality of media type access categories; and
send the load leveling information to at least one mobile client device.

23. An infrastructure device according to claim 22, wherein the media type access categories correspond to a plurality of WMM/WME access categories.

24. An infrastructure device according to claim 22, wherein the load leveling information comprises:
a total count of the mobile client devices associated with each media type access category for the infrastructure device, frames per second, bytes per second, a percent bandwidth utilized per access category, and a total percent bandwidth available on a data communication channel in the wireless network.

25. An infrastructure device according to claim 22, wherein the media type access categories correspond to a set of priority levels based upon data type.

26. An infrastructure device according to claim 25, wherein the set of priority levels includes a voice priority level, a video priority level, a best effort priority level, and a background priority level.

27. An infrastructure device according to claim 22, wherein the load leveling information comprises a first current load indicator for a first media type access category and a second current load indicator for a second media type access category.
